(19) United States
(12) Patent Application Publication
(10) Pub. No.: US 2018/0179066 A1
(43) Pub. Date: Jun. 28, 2018

(54) CARBON-METAL COMPOSITE

(71) Applicant: Panasonic Intellectual Property Management co.,Ltd, Osaka (JP)

(72) Inventors: NAOMI NISHIKI, Kyoto (JP); HIDETOSHI KITAURA, Osaka (JP); ATSUSHI TANAKA, Osaka (JP); RYOU KUWABARA, Osaka (JP); TAKESHI NISHIKAWA, Osaka (JP)

(21) Appl. No.: 15/730,692

(22) Filed: Oct. 11, 2017

(30) Foreign Application Priority Data
Dec. 28, 2016 (JP) 2016-255387

(51) Int. Cl. C01B 32/21; B22F 1/02; B22F 1/00

(52) U.S. Cl. CPC C01B 32/21; B22F 1/025; B22F 1/0055; B22F 2301/205; B22F 2301/10; B22F 2301/155; B22F 2301/255; B22F 2302/40

(57) ABSTRACT

A carbon-metal composite includes a flake-like graphite powder, and a metal covering a circumferential end portion of the flake-like graphite powder to thereby improve the contact resistance of crystalline graphite, and to provide a composition containing a carbon material having improved contact resistance.

### TECHNICAL FIELD

The technical field relates to carbon-metal composites used as additives for improving the thermal conductivity of rubber materials and resin materials.

### BACKGROUND

As the trend for smaller, thinner, and higher-performance electronic devices continues, it has become increasingly important to dissipate the neat generated inside these devices. In some devices, this is attained by taking ambient air with the use of a fan or other means. However, this approach is not applicable to mobile devices, such as smartphones and cameras, which are designed to avoid entry of dust and moisture. Instead, these devices use a method that disperses the heat in the device housing, or inside the device itself. This requires high thermal conductivity for the housing, and for materials used inside the device.

Carbon materials are a good thermal conductor, and can be used as additives in a powdery form to improve the thermal conductivity of rubber materials and resin materials. Rubber materials and resin materials have a thermal conductivity of about 0.1 to 0.3 W/mK, which can be improved by adding a carbon material powder (JP-A-2003-321554). Graphite is a highly crystalline carbon material, and is an excellent thermal conductor with a thermal conductivity of 1,000 W/mK or more in the basal plane (a plane parallel to the surface with a network of six-membered rings). Graphite, with such high crystallinity, can thus be used to further improve thermal conductivity when added in a powdery form (JP-A-2015-007162).

However, when the thermal conductivity of the added powder has directivity, the powder cannot effectively improve the thermal conductivity of the material unless the thermal conductivity of the powder is aligned upon contact. The graphite filler described in JP-A-2015-007162 has high crystallinity, and a person with ordinary skill in the art might think that the graphite filler described in this publication would improve thermal conductivity more effectively than in JP-A-2003-321554. However, because the added graphite fillers make random contact, the graphite does not align in a direction that provides high thermal conductivity, and it has not been possible thus far to fully exploit the high thermal conductivity of crystalline graphite.

### SUMMARY

This patent application is directed to improving the contact resistance (thermal contact resistance) of crystalline graphite, and providing a carbon material composition with improved contact resistance.

One aspect of the present disclose is a carbon-metal composite which includes a flake-like graphite powder, and a metal which covers only a circumferential end portion (metal-coveted circumferential end portion) of the flake-like graphite powder. In this way, the contact between the metal-covered circumferential end portions occurs preferentially over the high-contact-resistance contact between the circumferential end portion and the basal plane. It is thus possible to reduce the contact resistance.

According to another aspect of the present disclosure, the carbon-metal composite which includes the metal-covered circumferential end portion of the flake-like graphite powder is added to improve the thermal conductivity of rubber material or resin material. This reduces the contact resistance, and transfer of heat becomes more likely to occur along the basal plane direction where the graphite has high thermal conductivity. It is thus possible to effectively improve the thermal conductivity of rubber material and resin material.

### BRIEF DESCRIPTION OF THE DRAWINGS

FIG. 1 is a schematic view of a carbon-metal composite having a metal at only the circumferential end portion of a flake-like graphite.

FIG. 2 is a schematic view of carbon-metal composites contacting at circumferential end portions.

FIG. 3 is a schematic view representing an angle created, by the surface of a rubber or resin material, and the basal plane of the flake-like graphite powder.

FIG. 4 is a diagram representing the result of the measurement for Example 1.

### DESCRIPTION OF EMBODIMENTS

An embodiment of the present disclosure is described below with reference to the accompanying drawings.

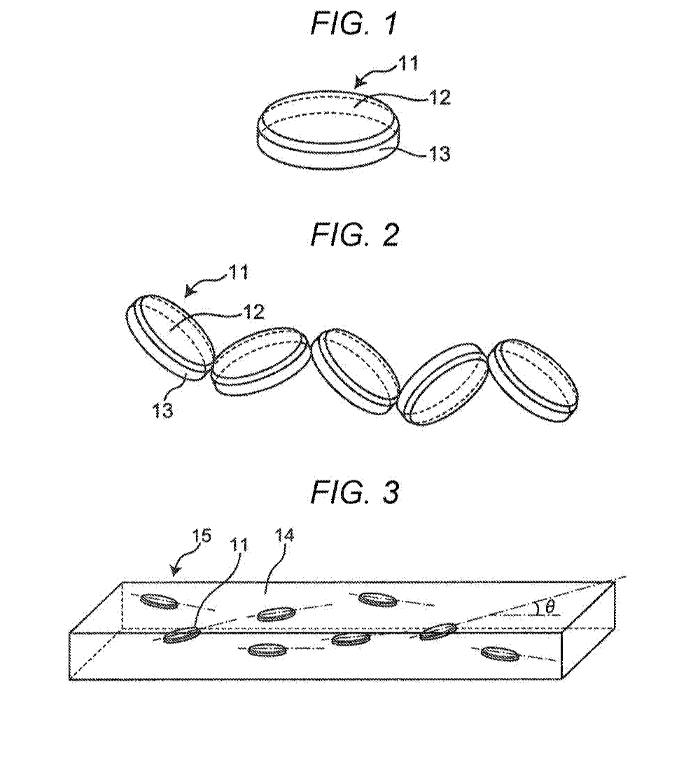

As illustrated in FIG. 1, a carbon-metal composite 11 of the embodiment of the present disclosure includes a flake-like graphite powder 12, and a metal 13 covering a circumferential end portion of the flake-like graphite powder 12. A rubber or a resin composition 15 is formed by adding a carbon-metal composite 11 of the embodiment of the present disclosure to a rubber or a resin material 14, as depicted In FIG. 3.

### Flake-Like Graphite Powder 12

As used herein, flake-like graphite is a graphite with a thickness having a top surface and a bottom surface. The top and bottom surfaces of the flake-like graphite are parallel to the surface with a network of six-membered rings (basal plane) of the graphite, As used herein, the “major axis” of the flake-like graphite is the average length of the longest line connecting any two points on the outer contour of the top surface of the flake-like graphite, and the longest line connecting any two points on the outer contour of the bottom surface of the flake-like graphite. As used herein, the “thickness” of the flake-like graphite is the average distance between the top surface and the bottom surface. As used herein, “flake-like graphite powder” means a powder obtained by pulverising the flake-like graphite. As used herein, the “circumferential end portion” of the flake-like graphite is the surface portion located on the side between, the top surface and the bottom surface of the flake-like graphite.

The flake-like graphite powder 12 of the embodiment of the present disclosure has a thermal conductivity of 1,000 W/mK or more in a basal plane direction, and a thermal conductivity of about 10 W/mK in a direction perpendicular to the basal plane. That is, the thermal conductivity of the flake-like graphite powder 12 greatly differs for a basal plane direction and a direction perpendicular to the basal plane. This is because the carbon atoms are strongly bonded to each other by covalent bonding in a basal plane direction, whereas only weak Van der Waals bonds hold the carbon atoms together in a direction perpendicular to the basal plane. In the flake-like graphite powder 12, the thermal conductivity difference between the two directions is attributed to the difference in the bonding force acting in these directions.

When the graphite powder has a flake-like shape with a considerably smaller thickness relative to the major axis, the basal plane of a compact obtained by packing the powder is parallel to the pressed surface. X-ray diffraction measurement of the pressed surface can thus provide the X-ray diffraction intensity of the basal plane for a large numbers of graphite powders. The X-ray diffraction intensity can be regarded as the mean value of the X-ray diffraction measurements of a single flake-like graphite powder, and the FWHM (full width at half maximum) of the X-ray diffraction intensity can be regarded as the mean value of the FWHM by X-ray diffraction of a single flake-like graphite powder. The flake-like graphite powder 12 of the embodiment of the present disclosure has a FWHM of preferably 15 degrees or less in X-ray diffraction of the basal plane.

The FWHM by X-ray diffraction of the basal plane of the flake-like graphite powder 12 falls within this range because the flake-like graphite powder 12 has a high percentage of graphite, and forms a laminar structure of graphite.

The flake-like graphite powder 12 can be obtained by forming a powder of highly crystalline graphite. The flake-like graphite powder 12 obtained in this manner has a major axis measuring 0.1 μm to 1 mm, and a thickness that is several tenths of the major axis. Preferably, the flake-like graphite powder 12 of the present disclosure has a major axis of 0.1 μm to 1 mm. With this range of major axis, the crystalline structure becomes unlikely to have defects, and the thermal conductivity improves. In the flake-like graphite powder 12 of the embodiment of the present disclosure, the ratio of the major axis to the thickness is preferably 5 to 80. With this range of a major axis-to-thickness ratio, the crystalline structure becomes unlikely to have defects, and the thermal conductivity improves.

### Metal 13

The flake-like graphite powder 12 has its circumferential end portion covered with the metal 13. The metal 13 needs to cover at least a part of the circumferential end portion, and preferably covers the whole circumferential end portion. With the metal 13 covering the circumferential end portion of the flake-like graphite powder 12, the contact between the metal-covered circumferential end portions occurs more preferentially over the high-contact-resistance contact between the circumferential end portion and the basal plane. This makes it possible to reduce the contact resistance between the carbon-metal composites 11. The metal 13 at the circumferential end portion may be any metal that can be combined with the flake-like graphite powder 12. Examples of suitable metals include, but are not limited to, copper, nickel, chromium, gold, platinum, silver, zinc, tin, silicon, tungsten, and titanium. By using these metals for the metal 13 at the circumferential end portion, only the direction with high thermal conductivity will be exploited in the anisotropic material graphite.

Preferably, the metal 13 is formed on the circumferential end portion of the flake-like graphite powder 12 using a CVD method or a plating method. It is possible, however, to use chemical coating or spraying. The metal 13 can be formed to cover the circumferential end portion without essentially covering the basal plane of the flake-like graphite powder 12 because the circumferential end portion of the flake-like graphite powder 12 has carbon atoms that are only weakly bonded to oxygen atoms or hydrogen atoms, and can easily bind to the metal 13 by breaking such weak bonds, whereas the carbon atoms on the surface of the basal plane are strongly bonded to each other by carbon-carbon covalent bonding. The carbon-metal composite 11 can be produced by forming the metal 13 at the circumferential end portion of the flake-like graphite powder 12 using the foregoing method.

### Rubber or Resin Material 14

The carbon-metal composite 11 may be added to any rubber material. Preferred examples of rubber material include, but are not limited to, natural rubber, butyl rubber, ethylene propylene rubber, and silicone rubber.

The carbon-metal composite 11 may be added to any resin material. Preferred examples of resin material include, but are not limited to, thermoplastic resins. Use of a thermoplastic resin material makes it easier to knead the graphite powder.

### Rubber or Resin Composition 15

The rubber or resin composition 15 is obtained by adding the carbon-metal composite 11 to the rubber or resin material 14. The rubber or resin composition 15 contains the carbon-metal composite 11, and has improved, directional thermal conductivity. Preferably, the carbon-metal composite 11 is added, to the rubber or resin material 14 is an amount of 35 wt % to 70 wt % by mass with respect to the total mass of the rubber or resin material 14.

Kneading additives with high thermal conductivity in the rubber or resin material 14 means that large numbers of additives having high thermal conductivity will be present in the low-thermal-conductivity matrix of the rubber or resin material 14. As a rule, the thermal conductivity of the rubber or resin material increases as the number of high-thermal-conductivity additives increases. However, in the present disclosure, the thermal conductivity of the rubber or resin material does not easily improve when the carbon-metal composite 11 occurs in a zigzag arrangement, and has a long thermal conduction pathway as schematically illustrated in FIG. 2.

By applying a shear force or pressure to the rubber or resin composition 15 of the present disclosure, the angle created between the basal plane of the flake-like graphite powder 12 and the surface of the rubber or resin material 14 (angle θ in FIG. 3) can take a value of 1 to 10 degrees, on average. With the basal plane of the flake-like graphite powder 12 of the embodiment of the present disclosure being close to parallel to the surface of the rubber or resin material 14, the thermal conduction pathway becomes shorter, and the thermal conductivity of the rubber or resin composition 15 is improved compared to the thermal conductivity of the rubber or resin material 14. Pressure may be applied by calender molding, whereby the rubber or resin composition 15 is continuously fed between at least a pair of rolls. Alternatively, the rubber or resin composition 15 may be molded by being extruded after being sufficiently kneaded with a sealed kneading machine such as a Banbury mixer.

In the rubber or resin composition 15 of the embodiment of the present disclosure, the angle θ between the basal plane of the flake-like graphite powder 12 and the surface of the rubber or resin material 14 may be measured by observing a cross section taken perpendicular to the surface of the rubber or resin material.

The rubber or resin material 14 has a thermal conductivity of about 0.1 to 0.3 W/mK. However, the thermal conductivity can be improved to about 100 W/mK by adding the carbon-metal composite 11 of the embodiment of the present disclosure.

### EXAMPLES

### Example 1

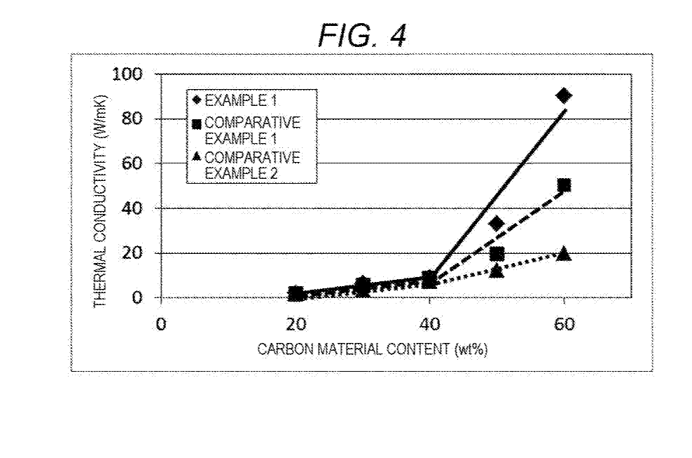

The carbon-metal composite 11 was added in varying proportions (carbon-metal composite content) of 20 wt %, 30 wt %, 40 wt %, 50 wt %, and 60 wt % with respect to the total mass of the rubber composition 15, and the thermal conductivity was measured for a direction parallel to the surface of the rubber composition 15. Changes in the thermal conductivity of the rubber composition 15 with varying contents of the carbon-metal composite 11 are shown in FIG. 4 (Example 1-1). Butyl rubber (thermal conductivity of 0.15 W/mK) was used as the rubber material 14. For the carbon-metal composite 11, a flake-like graphite powder 12 was used that had copper at the circumferential end portion, and a major axis distribution with a median value of 50 μm. Before forming the copper at the circumferential end portion, the flake-like graphite powder 12 was placed in a mold measuring 10 mm in diameter, and a pressure of 100 kg/cm² (9.8 MPa) was applied to produce a plurality of compacts having a thickness of 1 mm. The measured FWHM of the X-ray diffraction intensity of the pressed surface of the compact using a RIMNT (available from Rigaku Corporation) was 15 degrees or less in all samples.

For comparison, a flake-like graphite powder having a major axis distribution with a median value of 50 μm was added to butyl rubber (thermal conductivity of 0.15 W/mK), and the mixture was kneaded and molded. FIG. 4 shows changes in the thermal conductivity of the mixture with-varying mass fractions, 20 wt %, 30 wt %, 40 wt %, 50wt %, and 60 wt %, of the flake-like graphite powder with respect to the total mass of the mixture (Comparative Example 1-1).

For comparison, a carbon black having a particle size distribution with a median value of 0.5 μm was added to butyl rubber (thermal conductivity of 0.15 W/mK), and the mixture was kneaded and molded. FIG. 4 shows changes in the thermal conductivity of the mixture with varying mass fractions, 20 wt %, 40 wt %, 50 wt %, and 60 wt %, of the carbon, black powder with respect to the total mass of the mixture (Comparative Example 1-2).

### Example 2

Butyl rubber (thermal conductivity of 0.15 W/mK) was used as the rubber material. For the carbon-metal composite 11, a flake-like graphite powder 12 was used that had the metal 13 at the circumferential end portion, and a major axis distribution with a median value of 50 μm. The rubber composition 15 was measured for plane-direction thermal conductivity with different metals at the circumferential end portion. The metals used for the circumferential end portion are shown in Table 1 (Examples 2-1 to 2-11).

For comparison, a flake-like graphite powder having a major axis distribution with a median value of 50 μm was added to butyl rubber (thermal conductivity of 0.15 W/mK), and the mixture was kneaded and molded (Comparative Example 2-1).

### Example 3

A carbon-metal composite 11 prepared by forming copper on the circumferential end portion of the flake-like graphite powder 12 having a major axis distribution with a median value of 50 μm was added to a polypropylene resin thermal conductivity of 0.13 W/mK), and the mixture was kneaded and molded to produce a resin composition 15 (Example 3-1). The mass fraction of the carbon-metal composite 11 with respect to the total mass of the resin composition 15 was 50 wt %.

For comparison, a flake-like graphite powder having a major axis distribution with a median value of 50 μm was added to a polypropylene resin (thermal conductivity of 0.13 W/mK), and the mixture was kneaded and molded (Comparative Example 3-1). The mass fraction of the flake-like graphite powder with respect to the total mass of the mixture was 50 wt %.

The result for Example 1 is shown in the graph of FIG. 4. In Comparative Example 1-2 in which carbon black was added, the thermal conductivity linearly increased with increase in carbon black content. In contrast, in Comparative Example 1-1 and Present Example 1-1 in which the flake-like graphite powder was added, the thermal conductivity rapidly increased when the content of the flake-like graphite powder exceeded about 40 wt %. This is the result of the increased flake-like graphite powder content bringing the flake-like graphite powders into contact at an increased rate. In Example 1-1, the flake-like graphite powder uses copper as the metal 13 formed at the circumferential end portion, and has a reduced contact resistance. Accordingly, the rate of increase is more prominent than, in Comparative Example 1-1.

The results for Example 2 are summarized in the Table 1 below.

TABLE 1

| | Metallic | Thermal conduc- | Thermal conduc- |
|---|---|---|---|
| | material | tivity in | tivity ratio |
| | at circumfer- | basal plane | relative to |
| | ential end | direction | Comparative |
| | portion | (W/mK) | Example 1 |
| Example 2-1 | Copper | 33.3 | 1.7 |
| Example 2-2 | Nickel | 25.9 | 1.3 |
| Example 2-3 | Chromium | 25.9 | 1.3 |
| Example 2-4 | Gold | 31.4 | 1.6 |
| Example 2-5 | Platinum | 25.4 | 1.3 |
| Example 2-6 | Silver | 33.9 | 1.7 |
| Example 2-7 | Zinc | 26.4 | 1.4 |
| Example 2-8 | Tin | 25.2 | 1.3 |
| Example 2-9 | Silicon | 27.0 | 1.4 |
| Example 2-10 | Tungsten | 27.9 | 1.4 |
| Example 2-11 | Titanium | 24.2 | 1.2 |
| Comparative | None | 19.5 | 1.0 |
| Example 2-1 | | | |

The rubber composition of Comparative Example 2-1 that contained the flake-like graphite powder without using metal at the circumferential end portion had a thermal conductivity of 19.5 W/mK. The rubber compositions of Examples 2-1 to 2-11 had thermal conductivities that were 1.2 to 1.7 times higher than the thermal conductivity observed in Comparative Example 2-1. Presumably, this is due to the metal 13 formed at the circumferential end portion of the flake-like graphite powder 12 contained in the rubber compositions of Examples 2-1 to 2-11, and the reduced contact resistance due to the more preferential contact occurring between the metal-covered circumferential end portions than the high-contact-resistance contact between the circumferential end portion and the basal plane.

In Example 3, the thermal conductivity was 21 W/mK in Example 3-1, as opposed to 15 W/mK in Comparative Example 3-1. From these results, the resin composition 15 of the embodiment of the present disclosure obtained by adding the carbon-metal composite 11 to the resin material 14 was found to have marked improvement of thermal conductivity over the mixture obtained by adding a carbon material to the resin material.

### INDUSTRIAL APPLICABILITY

The carbon-metal composite embodiment of the present disclosure is a material intended to manage the internal heat that is generated due to performance improvement and miniaturization in electronic devices, particularly in mobile devices such as laptop personal computers, tablets, smartphones, cell phones, wearable devices, digital cameras, and digital movie cameras. The carbon-metal composite embodiment of the present disclosure is also applicable to industrial devices in which the thermal conductive paste used to reduce the contact heat resistance loss exceeds the thermal limits, and to outdoor devices exposed to ultraviolet light, for example.

1. A carbon-metal composite comprising:
a flake-like graphite powder; and
a metal covering only a circumferential end portion of the flake-like graphite powder,
wherein the flake-like graphite powder has a thermal conductivity of 1,000 W/mK or more in a basal plane direction, and a thermal conductivity of about 10 W/mK in a direction perpendicular to the basal plane.

2. The carbon-metal composite according to claim 1, wherein the flake-like graphite powder has a major axis of 0.1 μm to 1 mm, a ratio of the major axis to a thickness of the flake-like graphite powder being 5 to 80, and wherein the flake-like graphite powder has a full width at half maximum (FWHM) of 15 degrees or less in X-ray diffraction of a basal plane.

3. The carbon-metal composite according to claim 2, wherein the metal is at least one selected from the group consisting of copper, nickel, chromium, gold, platinum, silver, zinc, tin, silicon, tungsten, and titanium.

4. The carbon-metal composite according to claim 1, wherein the metal is at least one selected from the group consisting of copper, nickel, chromium, gold, platinum, silver, zinc, tin, silicon, tungsten, and titanium.

5. A rubber material including the carbon-metal composite according to claim 1.

6. A resin material including the carbon-metal composite according to claim 1.
